(19) United States
(12) Patent Application Publication
(10) Pub. No.: US 2010/0135803 A1
(43) Pub. Date: Jun. 3, 2010

(54) SYSTEMS AND METHODS FOR GENERATING ENERGY USING WIND POWER

(76) Inventor: Satwant S. GREWAL, San Jose, CA (US)

Correspondence Address: Vista IP Law Group, LLP, 1885 Lundy Ave., Suite 108, San Jose, CA, 95131, US

(21) Appl. No.: 12/622,406

(22) Filed: Nov. 19, 2009

Related U.S. Application Data
(63) Continuation-in-part of application No. 12/276,048, filed on Nov. 21, 2008.

(51) Int. Cl. F03D 3/02

(52) U.S. Cl. 416/128; 416/120

(57) ABSTRACT

A wind turbine for generating energy includes a first rotor having a first set of blades and a first shaft, and a second rotor having a second set of blades and a second shaft, wherein the first rotor is configured to rotate in a first direction, and the second rotor is configured to rotate in a second direction that is opposite to the first direction. A wind turbine for generating energy includes a first rotor having a first set of blades and a first shaft, and a second rotor having a second set of blades and a second shaft, wherein one of the first set of blades is oriented to receive wind for turning the first rotor, and wherein one of the second set of blades is oriented an at angle to receive wind that is deflected from one of the first set of blades for turning the second rotor.

### RELATED APPLICATION DATA

This application is a continuation-in-part of U.S. patent application Ser. No. 12/276,048, filed on Nov. 21, 2008, the entire disclosure of which is expressly incorporated by reference herein.

### FIELD

This application relates generally to systems and methods for generating energy, such as electrical energy, using wind power.

### BACKGROUND

Wind turbines have been used to generate electrical energy from wind power. While existing wind turbines may provide some energy, they are not very efficient. This is because existing wind turbines can make use of only some of the wind power received directly by rotors of the wind turbines for conversion to electrical energy. Wind reflected from such rotors is not reused.

### SUMMARY

In accordance with some embodiments, a wind turbine for generating energy includes a first rotor having a first set of blades and a first shaft, and a second rotor having a second set of blades and a second shaft, wherein the first rotor is configured to rotate in a first direction, and the second rotor is configured to rotate in a second direction that is opposite to the first direction.

In accordance with other embodiments, a wind turbine for generating energy includes a first rotor having a first set of blades and a first shaft, and a second rotor having a second set of blades and a second shaft, wherein one of the first set of blades is oriented to receive wind for turning the first rotor, and wherein one of the second set of blades is oriented an at angle to receive wind that is deflected from one of the first set of blades for turning the second rotor.

Other and further aspects and features will be evident from reading the following detailed description of the embodiments, which are intended to illustrate, not limit, the invention.

### BRIEF DESCRIPTION OF THE DRAWINGS

The drawings illustrate the design and utility of embodiments, in which similar elements are referred to by common reference numerals. These drawings are not necessarily drawn to scale. In order to better appreciate how the above-recited and other advantages and objects are obtained, a more particular description of the embodiments will be rendered, which are illustrated in the accompanying drawings. These drawings depict only typical embodiments and are not therefore to be considered limiting of its scope.

FIG. 1 illustrates a wind turbine in accordance with some embodiments;

FIGS. 2A and 2B illustrate a first rotor for the wind turbine of FIG. 1 in accordance with some embodiments;

FIG. 2C illustrates a second rotor for the wind turbine of FIG. 1 in accordance with some embodiments;

FIG. 2D is an elevation view of the first and second rotors of FIGS. 2A and 2B, showing deflected wind;

FIGS. 3A and 3B illustrate a first rotor for the wind turbine of FIG. 1 in accordance with some embodiments;

FIG. 3C illustrates a second rotor for the wind turbine of FIG. 1 in accordance with some embodiments;

FIGS. 4A and 4B illustrate another rotor in accordance with other embodiments;

FIG. 5A illustrate a rotor in accordance with some embodiments, showing a blade's axis aligned with a radial axis of the rotor;

FIG. 5B illustrate a rotor in accordance with other embodiments, showing a blade's axis forming an angle with a radial axis of the rotor;

FIG. 6A illustrates components within a wind turbine in accordance with some embodiments;

FIG. 6B illustrates components within a wind turbine in accordance with other embodiments;

FIG. 7 illustrates a wind turbine in accordance with other embodiments;

FIG. 8 illustrates a wind turbine that has four rotors in accordance with some embodiments;

FIG. 9A illustrates a wind turbine that has three rotors in accordance with other embodiments;

FIG. 9B illustrates a wind turbine that has four rotors in accordance with some embodiments;

FIG. 10 illustrates a rotor in accordance with other embodiments;

FIG. 11 illustrates a rotor in accordance with other embodiments;

FIG. 12 illustrates a wind turbine in accordance with other embodiments;

FIG. 13 illustrates a wind turbine in accordance with other embodiments; and

FIG. 14 illustrates a portion of a wind turbine in accordance with other embodiments.

### DESCRIPTION OF THE EMBODIMENTS

Various embodiments are described hereinafter with reference to the figures. It should be noted that the figures are not drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated.

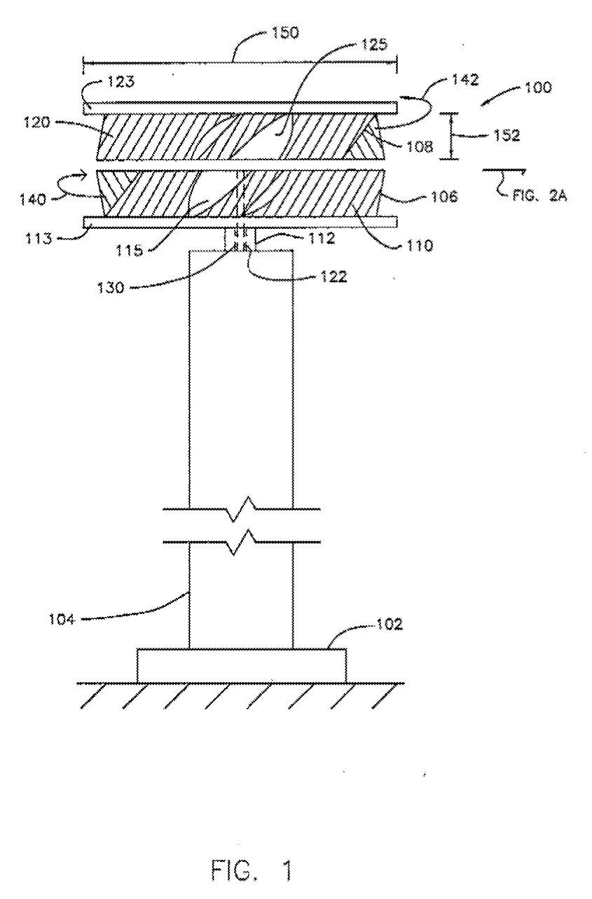

FIG. 1 illustrates a wind turbine 100 in accordance with some embodiments. The wind turbine 100 includes a base 102, a support structure 104, a first rotor 106, and a second rotor 108. The first and second rotors 106, 108 are coupled to the support structure, which supports the rotors 106, 108. The first and second rotors 106, 108 are configured to receive wind power, and rotate relative to the support structure 104 in response to the wind power. The wind turbine 100 also includes a generator (not shown), which is configured to convert rotational energy provided by the rotating rotors 106, 108 to electrical energy.

The first rotor 106 has a first set of blades 110 and a first shaft 112, and the second rotor 108 has a second set of blades 120 and a second shaft 122. The first set of blades 110 are supported on a plate 113 and are connected to a hub 115. The second set of blades 120 are supported on a plate 123 and are connected to a hub 125. As used in this specification, the term “blade” refers to any structure having a surface for allowing wind to push thereagainst, and is not limited to structure having a particular geometry. For example, in the illustrated embodiments, the blades 110, 120 each has a plate configuration. However, in other embodiments, each of the blades 110, 120 can have other configurations, such as a block-like configuration. Also, in other embodiments, the plates 113, 123 are not required, and the wind turbine 100 does not include the plates 113, 123. In such cases, each blade 110/120 will have an angle configuration that allows wind from one direction to be captured at the space between the legs of the angle. In other embodiments, the blade 110/120 can have other configurations as long as it can capture wind and utilize the wind power to turn the rotor.

The rotors 106, 108 can have different sizes in different embodiments. In some embodiments, each of the rotors 106, 108 may have a width that is between 2 inches and 1000 feet. For example, in some embodiments, each of the rotors 106, 108 has a width 150 that is between 5 feet and 500 feet, or more. In such cases, the support structure may be in the form of a tower. In other embodiments, each of the rotors 106, 108 has a width that is between 6 inches and 24 inches. In such cases, the support structure may be in the form of a hand-held device. The rotors 106, 108 can have other dimensions in other embodiments.

Also, each rotor 106/108 can have number of blades that are different from that shown. For example, each rotor 106/108 may have less than 6 blades or more than 6 blades. Also, in other embodiments, the number of blades for the first rotor 106 may be different from the number of blades for the second rotor 108.

In the illustrated embodiments, each of the hubs 115, 125 has a central opening. The second shaft 122 may be secured to the second rotor 108 by inserting part of the second shaft 122 into the hub's 125 opening, which provides a frictional fit to the second shaft 122. Alternatively, the second shaft 122 may be secured to the second rotor 108 using other mechanical devices, such as a connector, which may include one or more screws, etc. The first shaft 112 may be secured to the first rotor 106 using similar techniques. In some embodiments, the opening at the hub 125 is larger than the opening at the hub 115, so that the opening at the hub 125 can accommodate both the first shaft 112 and the second shaft 122. In other embodiments, the hub 125 does not include the opening, in which case, the shaft 122 may be secured to the bottom surface of the hub 125. As shown in the figure, the first shaft 112 of the first rotor 106 has an opening 130, and the second shaft 122 of the second rotor 108 is located within the opening 130 such that the second shaft 122 is located coaxially relative to the first shaft 112.

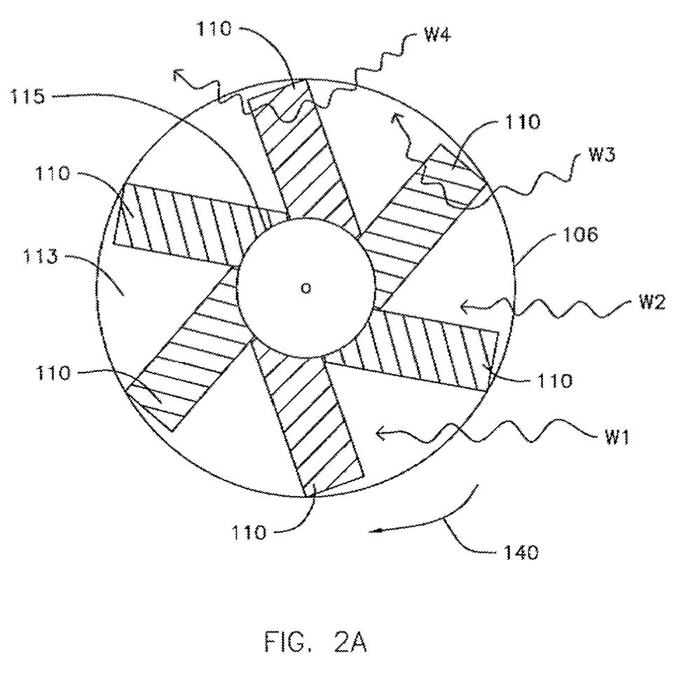

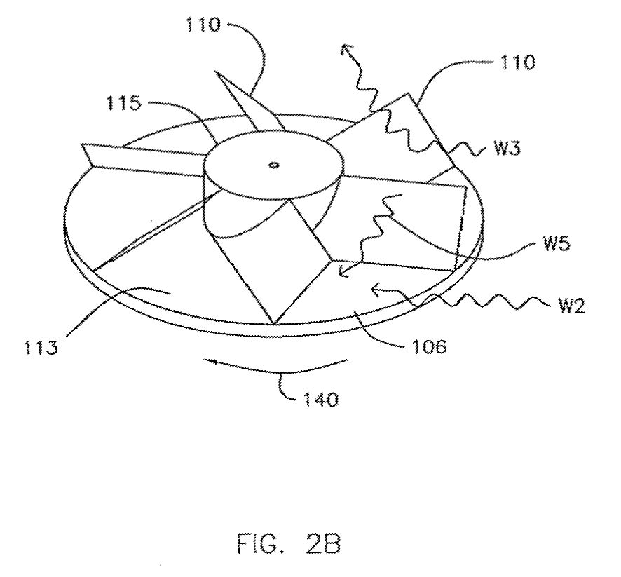

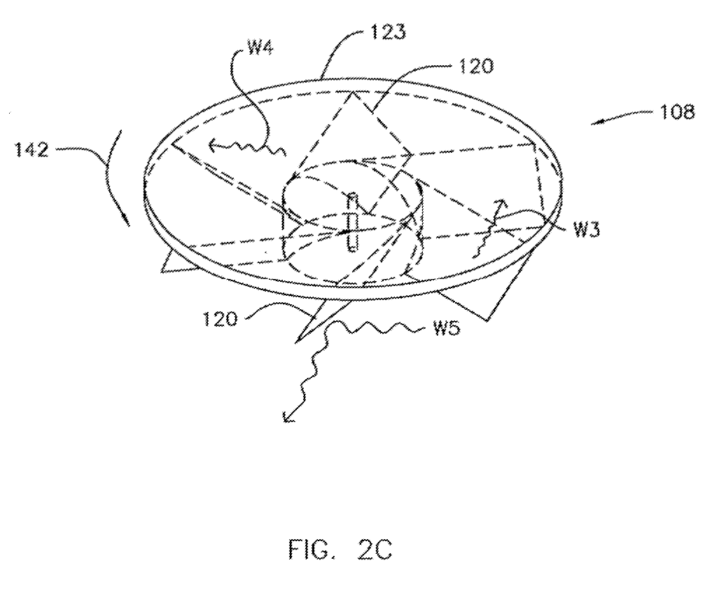

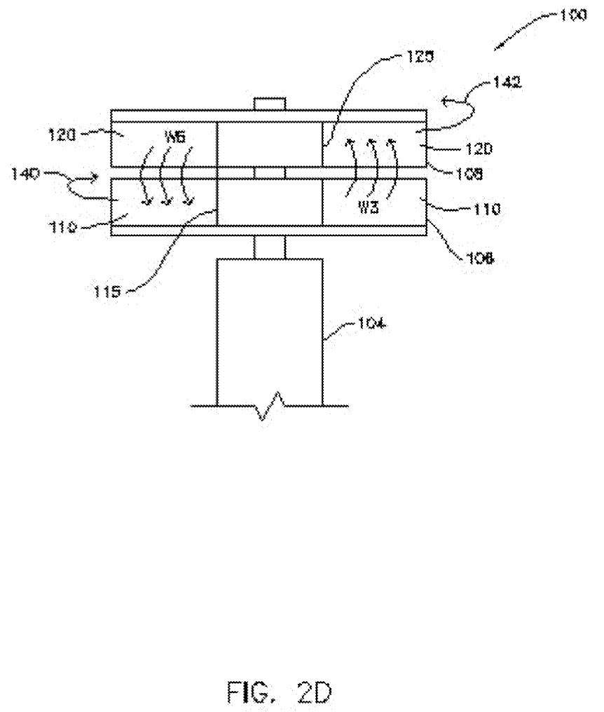

In the illustrated embodiments, the first rotor 106 is configured to rotate in a first direction 140, and the second rotor 108 is configured to rotate in a second direction 142 that is opposite to the first direction 140. Such is accomplished by orienting the first set of blades 110 relative to the second set of blades 120 such that wind deflected from a blade 110 in the first set is received by a blade 120 in the second set. During use, wind deflected from the first set of blades 110 is received by the second set of blades 120, which use the deflected wind from the first set of blades 110 to turn the second rotor 108. In some cases, the opposite may also happen—i.e., wind deflected from the second set of blades 120 is received by the first set of blades 110, which use the deflected wind from the second set of blades 120 to turn the first rotor 106. For example, as shown in FIG. 2A, wind W1, W2 may impinge upon two blades 110 of the first rotor 106, which capture the wind W1, W2 at the space that are formed between the blades 110 and the disk 113, thereby causing the rotor 106 to turn in the direction 140 shown. This is because the angle formed by the blade 110 and the disk 113 that is facing towards the on-coming wind (e.g., wind W1, W2) creates a significant drag to the wind, thereby allowing the blade 110 to utilize the wind power to turn the rotor 106. On the other hand, wind W3, W4 may impinge upon another two blades 110 of the first rotor 106, which deflect the wind upward as shown in the figure. The deflected wind W3, W4 are captured by the blades 120 of the second rotor 108 at the space that are formed between the blades 120 and the disk 123, thereby causing the second rotor 108 to turn in the direction 142 shown (FIG. 2C). Similarly, wind W5 that impinges upon another blade 120 for the second rotor 108 may be deflected downward, which in turn, is captured by the blade 110 of the first rotor 106 at the space that is formed between the blade 110 and the disk 113, thereby causing the first rotor 106 to turn in the direction 140 shown (FIG. 2B). FIG. 2D illustrates an elevation view of the first and second rotors 106, 108, showing wind W3 being deflected from blade 110 of the first rotor 106 to blade 120 of the second rotor 108, and wind W5 being deflected from blade 120 of the second rotor 108 to blade 110 of the first rotor 106.

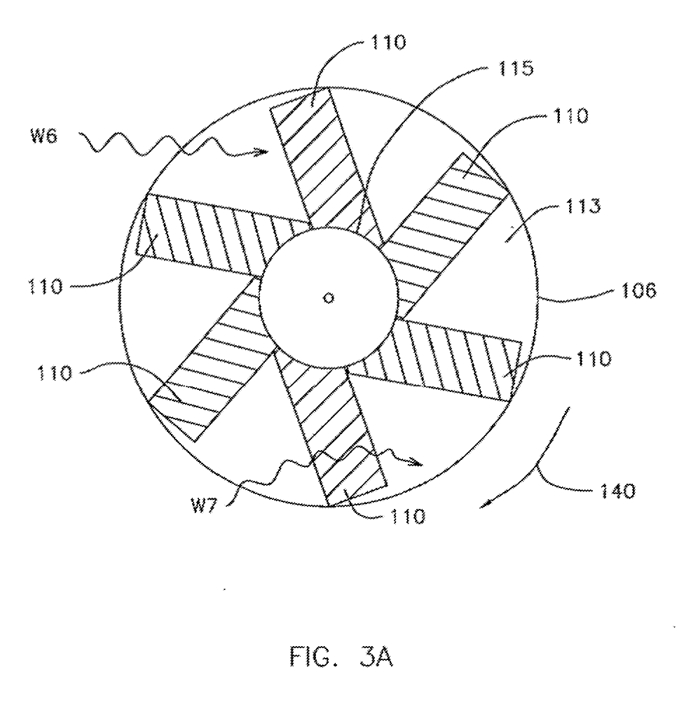

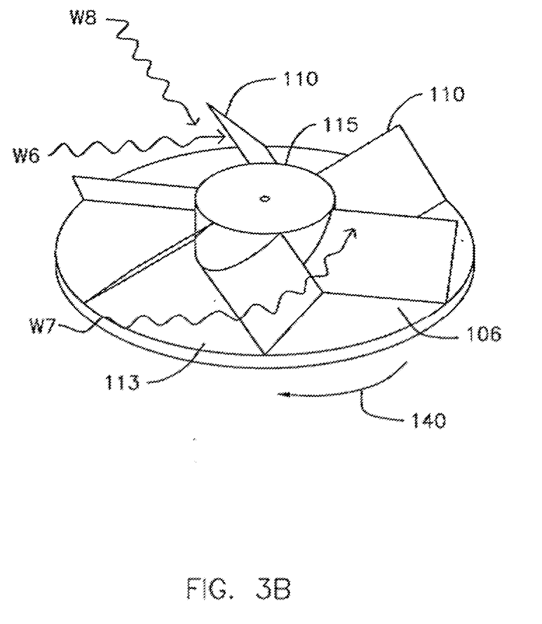

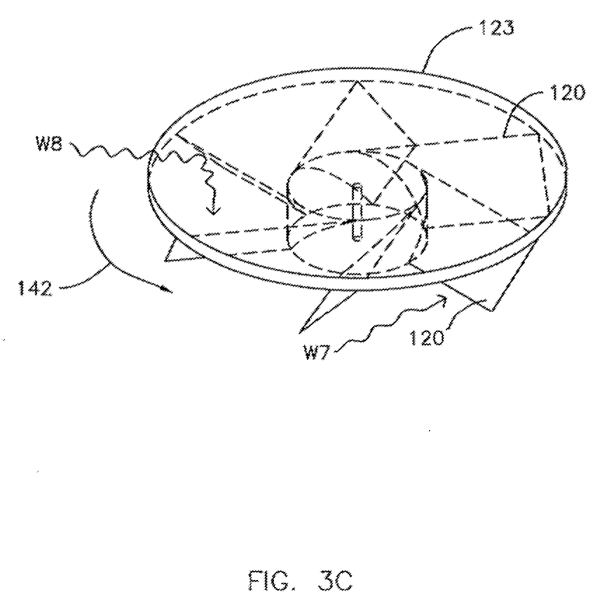

It should be noted that wind coming from the opposite direction as that shown in the figure would cause the rotors 106, 108 to operate in a similar manner. For example, as shown in FIG. 3A, wind W6 may impinge upon a blade 110 of the first rotor 106, which capture the wind W6 at the space that is formed between the blade 110 and the disk 113, thereby causing the rotor 106 to turn in the direction 140 shown. On the other hand, wind W7 may impinge upon another blade 110 of the first rotor 106, which deflect the wind upward as shown in the figures (FIGS. 3A, 3B). The deflected wind W7 is captured by the blade 120 of the second rotor 108 at the space that are formed between the blades 120 and the disk 123, thereby causing the second rotor 108 to turn in the direction 142 shown (FIG. 3C). Similarly, wind W8 that impinges upon another blade 120 of the second rotor 108 may be deflected downward, which in turn, is captured by the blade 110 of the first rotor 106 at the space that is formed between the blade 110 and the disk 113, thereby causing the first rotor 106 to turn in the direction 140 shown (FIG. 3B).

The above described feature is advantageous in that it allows deflected wind from the first rotor 106, which is otherwise lost or not utilized by the first rotor to generate energy, to be utilized by the second rotor 108, and vice versa. As illustrated in the embodiments, the amount of energy generated by oncoming wind is greatly increased by deflecting the wind in a bi-directional manner across the two sets of blades. In some embodiments, such feature provides at least a 50% energy efficiency, and in some cases, a 80% energy efficiency or more.

In the illustrated embodiments, each of the rotors 106, 108 has a circular disk configuration (FIG. 2A) in which the width 150 of the rotor is longer than the thickness 152. However, in other embodiments, the rotors 106, 108 may have a configuration that is different from that illustrated. For example, in other embodiments, each rotor may have a non-circular configuration, such as an elliptical configuration, a square configuration, a triangular configuration, a pentagonal configuration, a hexagonal configuration, etc. Also, in other embodiments, the thickness of the rotor may be the same or longer than the width of the rotor.

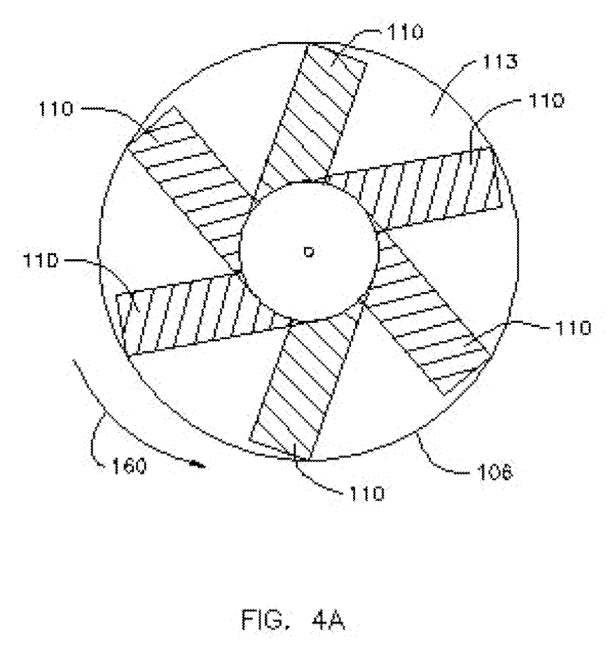

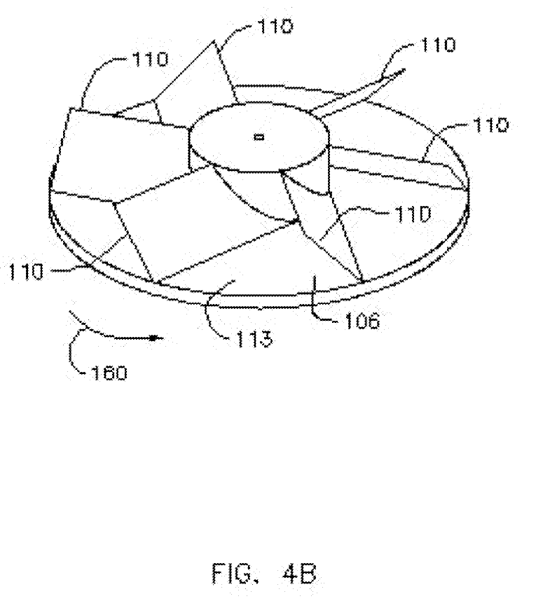

Also, in other embodiments, the rotors 106, 108 may be configured to rotate in respective directions that are opposite to those (directions 140, 142) illustrated in FIG. 1. FIGS. 4A and 4B illustrate a rotor 106 that is the same as that illustrated in FIG. 2, except that the blades 110 are oriented in different angles. Such configuration allows the rotor 106 to be rotated in the direction 160 shown. Similar is true with respect to the second rotor 108.

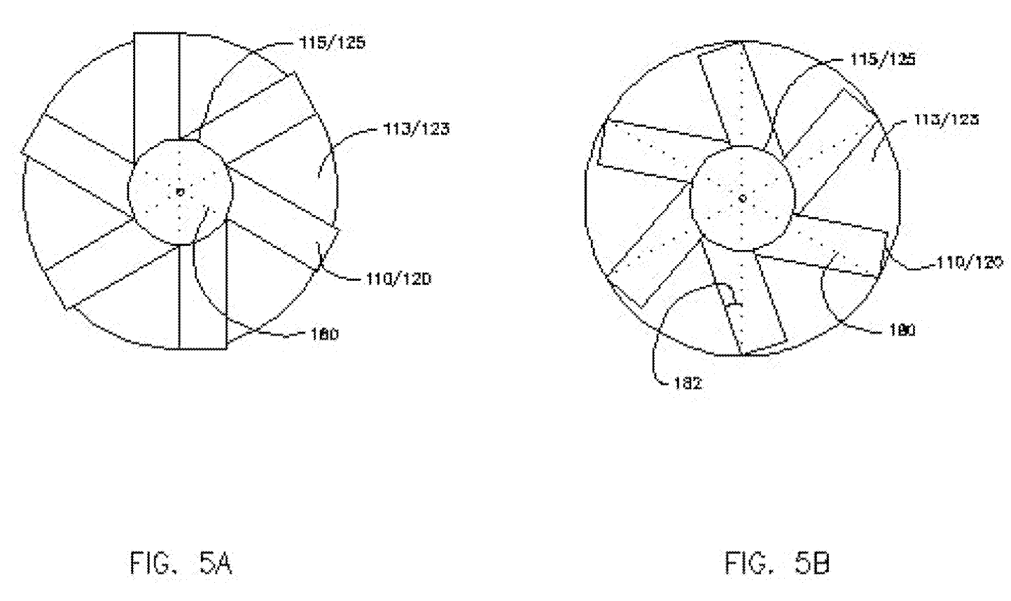

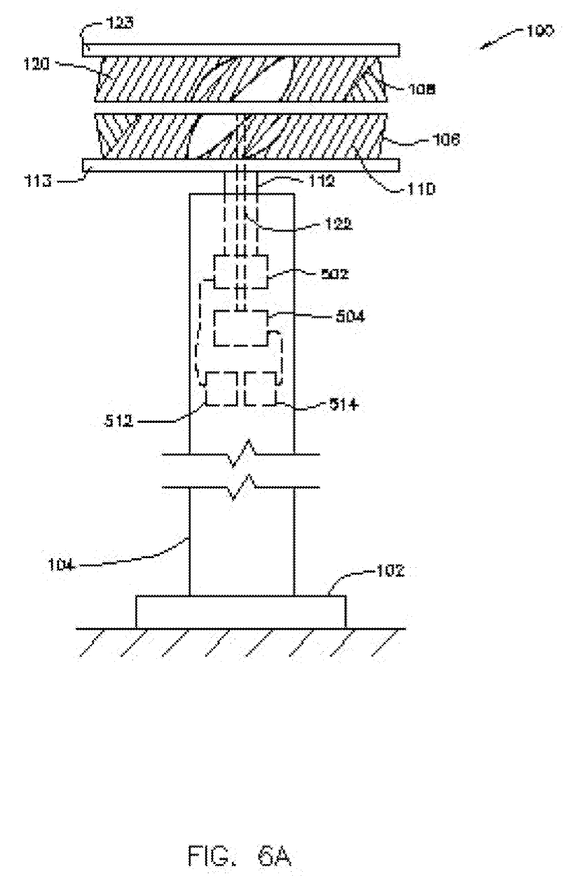

In any of the embodiments described herein, the blades 110/120 (e.g., edges of the blades) of the rotors 106/108 may align with respective radial axes 180 of the rotors 106/108 (FIG. 5A). In other embodiments, the blades 110/120 of the rotors 106/108 may form angles 182 with respective radial axes 180 of the rotors 106/108 (FIG. 5B). In some cases, such configuration may allow wind to be captured more efficiently.

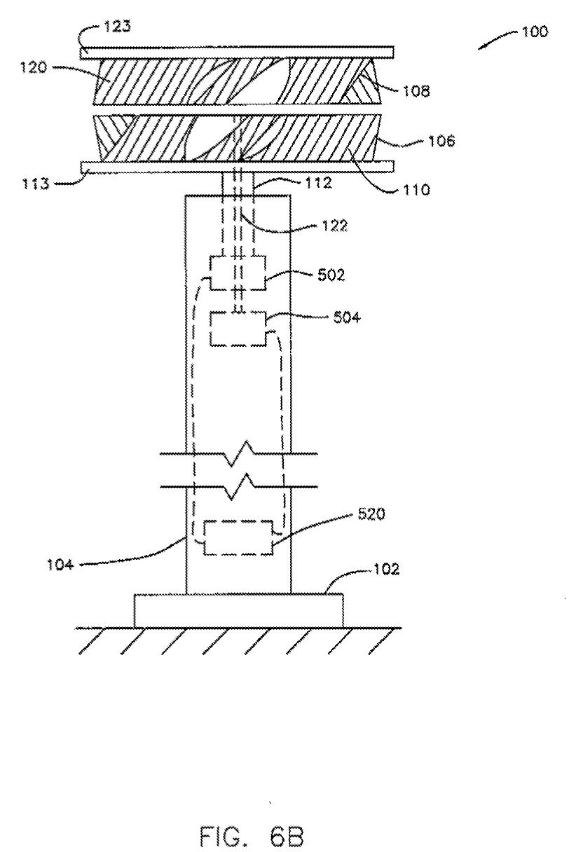

In any of the embodiments described herein, the wind turbine 100 may include one or more gearbox(es) for converting slowly rotating, high torque powers from the respective rotors to high speed, low torque power. For example, in some embodiments, the first shaft 112 is coupled to a first gearbox 502, and the second shaft 122 is coupled to a second gearbox 504 (FIG. 6A). The gearboxes 502, 504, are in turn, coupled to respective power generators 512, 514. The power generators 512, 514 are configured to convert rotational energy into electrical energy. Each of the power generators 512, 514 may be an induction generator, or other types of generator. In other embodiments, instead of having different gearboxes for the respective rotors, two (or more—if more than two rotors are provided) of the rotors of the wind turbine 100 can share the same gearbox. Also, in further embodiments, instead of having power generators 512, 514 for the respective rotors, the wind turbine 100 can have a single generator 520 for converting rotational energy from the rotors to electrical energy (FIG. 6B).

In other embodiments, the wind turbine 100 does not include any gearbox, and instead, relies on a direct drive. In such cases, the generator 13 may be a permanent magnet synchronous generator (PMSG) capable of generating power at a low rotational speed.

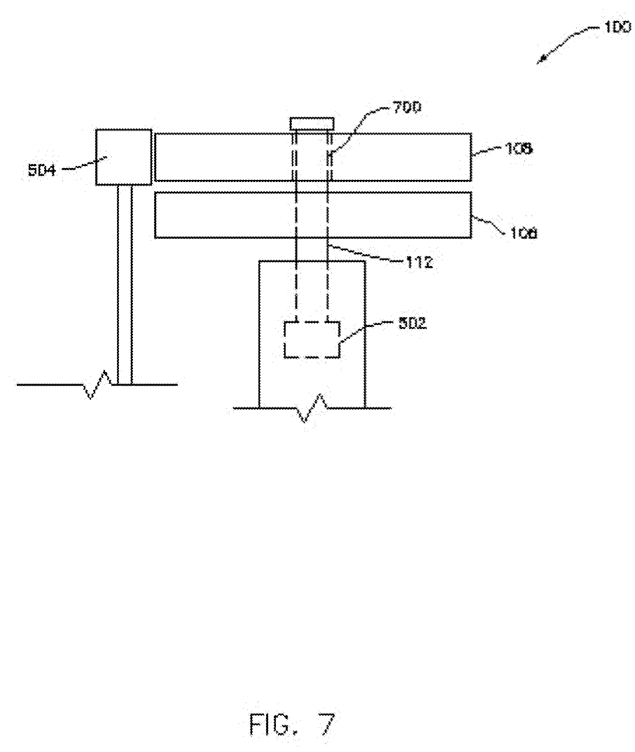

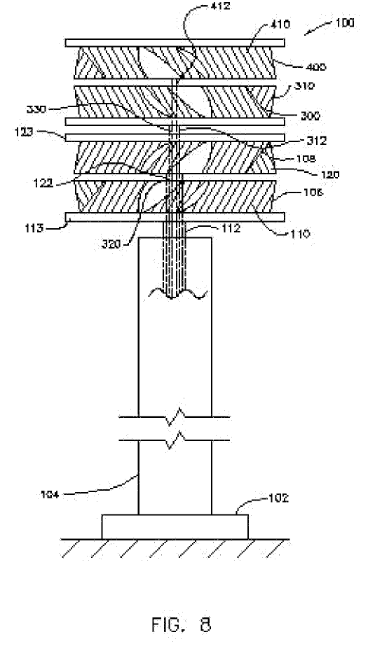

In the above embodiments, the wind turbine 100 has been described as having two shafts 112, 122 that are located co-axially relative to each other. In other embodiments, the wind turbine 100 needs not have such configuration. For example, in other embodiments, the first rotor 106 may be fixedly secured to the shaft 112, which extends through an opening 700 in the second rotor 108 (FIG. 7). In the figure, the blades are not shown for clarity. The shaft 112 is coupled to a first gearbox 502, and the second rotor 108 is coupled to a second gearbox 504. In some embodiments, the periphery of the second rotor 108 may include a saw-tooth structure that provide a gear function for the second rotor 108. The saw-tooth structure engages with a gear in the gearbox 504, and turns the gear at the gearbox 504 when the second rotor 108 rotates.

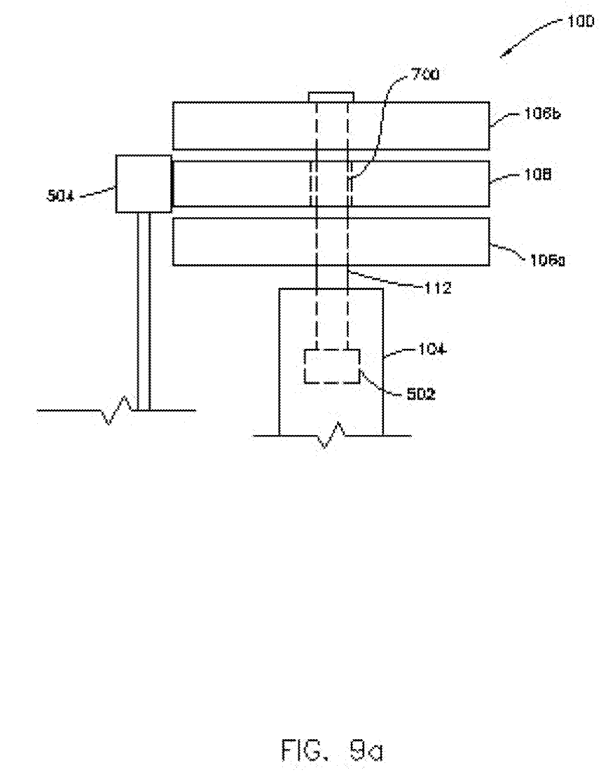

In any of the embodiments described herein, the wind turbine 100 may include additional rotors. For example, in other embodiments, the wind turbine 100 may include an additional pair of rotors, i.e., a third rotor 300 and a fourth rotor 400 (FIG. 8). In such cases, the third rotor 300 has a third set of blades 310 and a third shaft 312, and the fourth rotor 400 has a fourth set of blades 410 and a fourth shaft 412. In the illustrated embodiments, the second shaft 122 has an opening 320, and the third shaft 312 of the third rotor 300 is located within the opening 320 of the second shaft 122 such that the third shaft 312 is located coaxially relative to the second shaft 122. Also, the third shaft 312 has an opening 330, and the fourth shaft 412 of the fourth rotor 400 is located within the opening 330 of the third shaft 312 such that the fourth shaft 412 is located coaxially relative to the third shaft 312. During use, wind deflected from the third set of blades 310 is received by the fourth set of blades 410, which use the deflected wind from the third set of blades 310 to turn the fourth rotor 400. In some cases, the opposite may also happen—i.e., wind deflected from the fourth set of blades 410 is received by the third set of blades 310, which use the deflected wind from the fourth set of blades 410 to turn the third rotor 300.

In further embodiments, the wind turbine 100 may include more than four rotors. For example, in other embodiments, the wind turbine 100 may include six or more rotors, such as 10 rotors. In some cases, the turbine may include any number of rotors, and may be multi-tiered to include many groups or sets (e.g., groups or sets of two) of blades. The rotors may be aligned relative to each other to form a series. The rotors may also be aligned in different configurations in different embodiments.

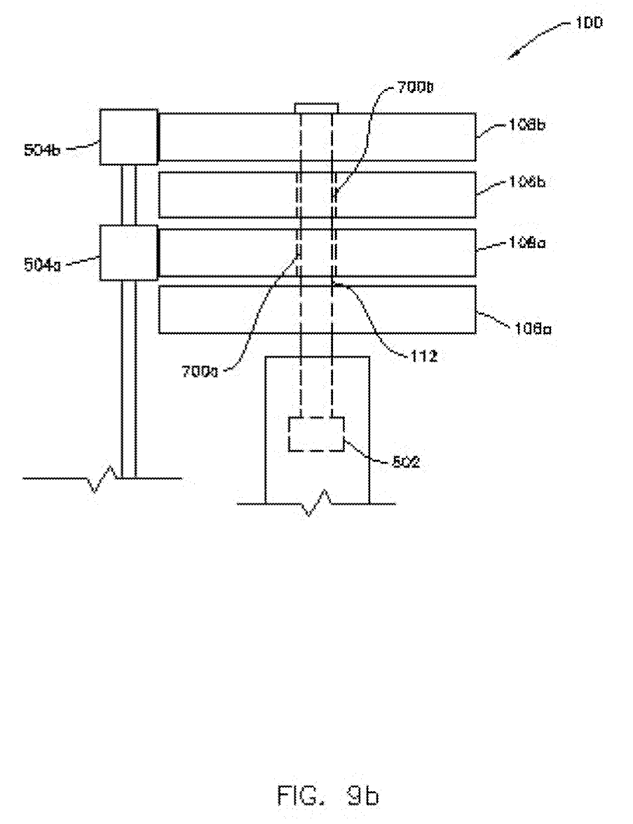

Similarly, for the embodiment of the wind turbine shown in FIG. 7, there can be more than two rotors 106, 108. FIG. 9A illustrates a variation of the wind turbine 100 of FIG. 7 in accordance with some embodiments. The wind turbine 100 includes three rotors 106a, 106b, 108. In the figure, the blades are not shown for clarity. The rotors 106a, 106b are both fixedly secured to the shaft 112. The shaft 112 extends through the opening 700 at the rotor 108, which can rotate relative to the shaft 112. The shaft 112 is coupled to a first gearbox 502. Thus, the rotating of the rotors 106a, 106b will cause the gearbox 502 to be activated (e.g., will move a component in the gearbox 502). The rotor 108 is coupled to a second gearbox 504 at its periphery (e.g., via saw-tooth structure, not shown), and rotation of the rotor 108 will cause the second gearbox 504 to be activated.

In other embodiments, the wind turbine of FIG. 9A can have one or more additional rotors. FIG. 9B illustrates a wind turbine 100 that has four rotors 106a, 106b, 108a, 108b. In the figure, the blades are not shown for clarity. The rotors 106a, 106b are fixedly secured to the shaft 112. The shaft 112 extends through the opening 700a at the rotor 108a, and the opening 700b at the rotor 108b. The rotors 108a, 108b can rotate relative to the shaft 112. In the illustrated embodiments, the rotating of the rotors 106a, 106b will activate the gearbox 502. The rotating of the rotors 108a, 108b will activate gearboxes 504a, 504b, respectively.

In other embodiments, the wind turbine 100 may include a first set of two or more rotors 106, and a second set of two or more rotors 108 that are staggered (e.g., in an alternating pattern) with the first set. In such cases, the rotors 106 may be all fixedly secured to the shaft 112. The rotors 108 are located between the rotors 106, and each rotor 108 includes an opening for allowing the shaft 112 to extend therethrough, thereby allowing each rotor 108 to rotate relative to the shaft 112. During use, the rotors 106 will all rotate in a first direction, and the rotors 108 will rotate in a second direction that is different from the first direction. The shaft 112 for the first set of rotors 106 may be coupled to a first gearbox, while the rotors 108 from the second set may be coupled to respective gearboxes at the respective peripheries of the rotors 108.

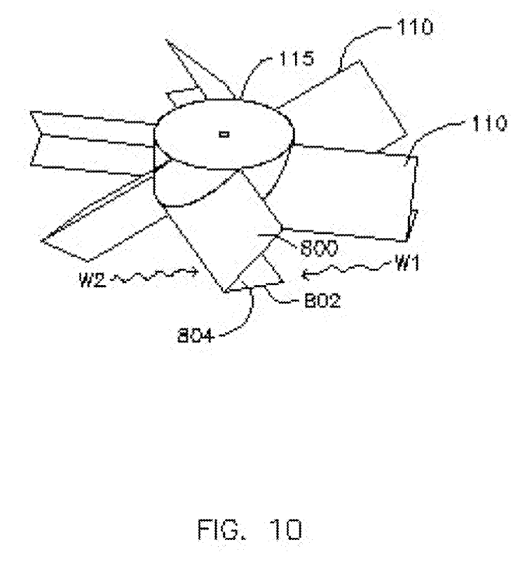

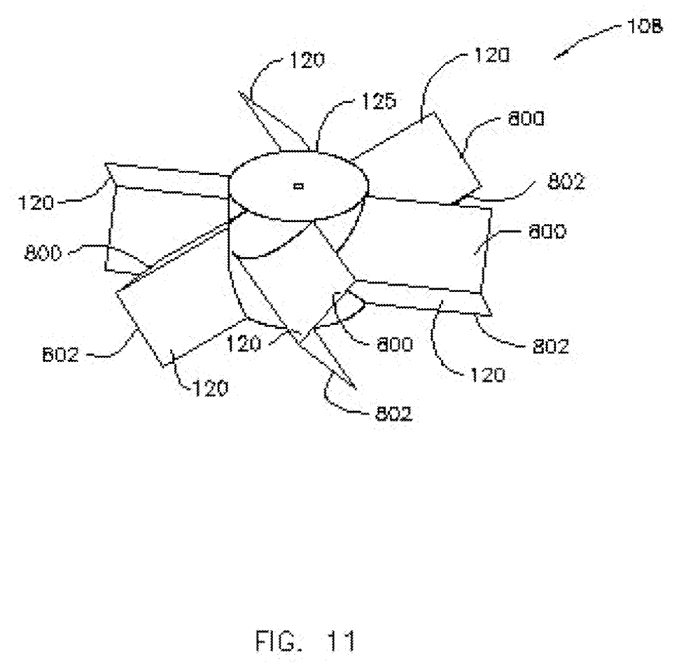

In any of the embodiments described herein, the rotor 106/108 may not include disk 113/123. For example, in some embodiments, the blades 110 may be secured to the hub 115 without any support by a disk 113 (FIG. 10). In such cases, each blade 110 may include a first portion 800 and a second portion 802, which together form an angle. During use, wind W1 coming from one direction is captured by the angle at the space 804 that is between the portions 800, 802. The angle creates a significant drag for the wind W1, thereby using the wind energy to turn the rotor. On the other hand, wind W2 coming from another direction is not captured by the angle, and is instead, deflected by the portion 800. The deflected wind may be captured by an adjacent rotor, which uses the deflected wind to turn the adjacent rotor, as similarly discussed herein.

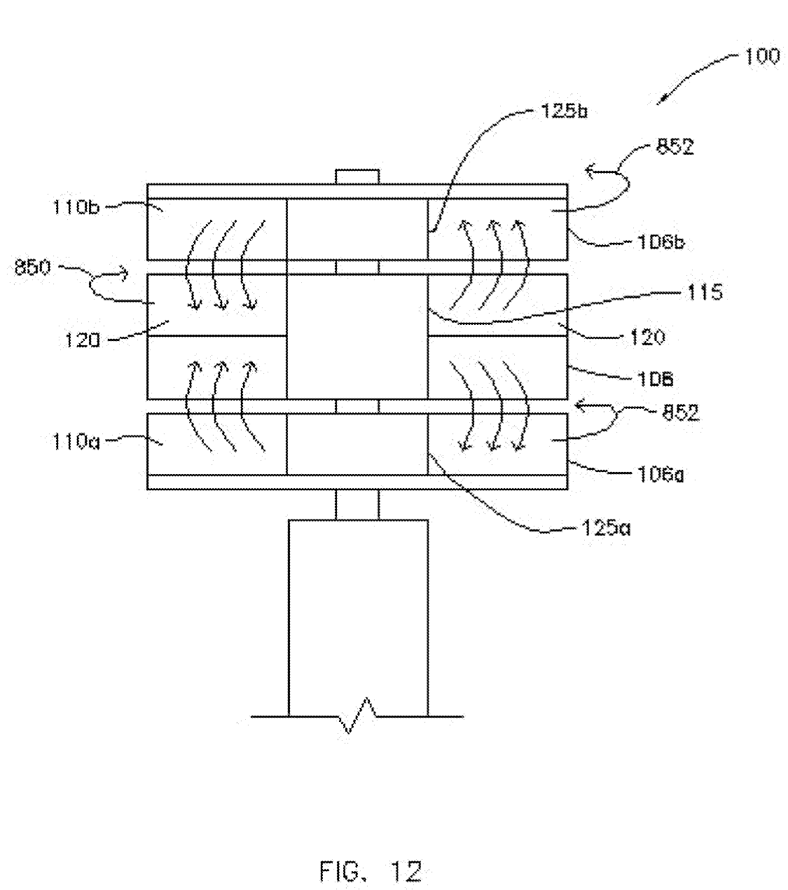

FIG. 11 illustrates another rotor, which may be used in any of the embodiments described herein. Unlike the rotor shown in FIG. 10 in which the second portion 802 is oriented horizontally, the rotor in FIG. 11 has second blade portions 802 that are not oriented horizontally. In some embodiments, such rotor may be used as the rotor 108 in the embodiment of FIG. 9A.

FIG. 12 illustrates a wind turbine 100 in accordance with other embodiments. The wind turbine 100 has three rotors 106a, 106b, 108. The rotor 108 has the configuration shown in FIG. 11, and the rotor 106a has the configuration shown in FIG. 4B. During use, wind is deflected from blades 110a, 110b (e.g., above and below the rotor 108 on one side of the hub 115) towards a blade 120 of the rotor 108. The deflected wind is received by the angle of the blade 120, and pushes the blade 120 to thereby rotate the rotor 108 in the direction 850. On the other side of the hub 115, wind is deflected from the first portion 800 and the second portion 802 of the blade 120 towards the rotor's 106b blade 110b, and the rotor's 106a blade 110a, respectively. The deflected wind is received by the blade 110a, and pushes the blade 110a to thereby rotate the rotor 106a in the direction 852. Similarly, the deflected wind is reflected by the blade 110b, and pushes the blade 110b to thereby rotate the rotor 106b in the direction 852, which is the same direction as that for the rotor 106a, but is in the opposite direction as that for the rotor 108. In some embodiments, the rotor 108 may be coupled to a gear box (not shown) at its periphery, as similarly described herein. Also, in other embodiments, instead of the rotor 106b, the wind turbine 100 may include another rotor having a configuration that is the same as the rotor 108, except that the blades 120 are reversed. In further embodiments, the wind turbine 100 may include more than two rotors 108, such as three rotors 108, four rotors 108, or more, that are stacked in an array. The rotors 108 may have respective blades 120 that alternate in orientation, such that every other rotors 108 in a first set would rotate in one direction, and the adjacent rotors in a second set would rotate in another direction.

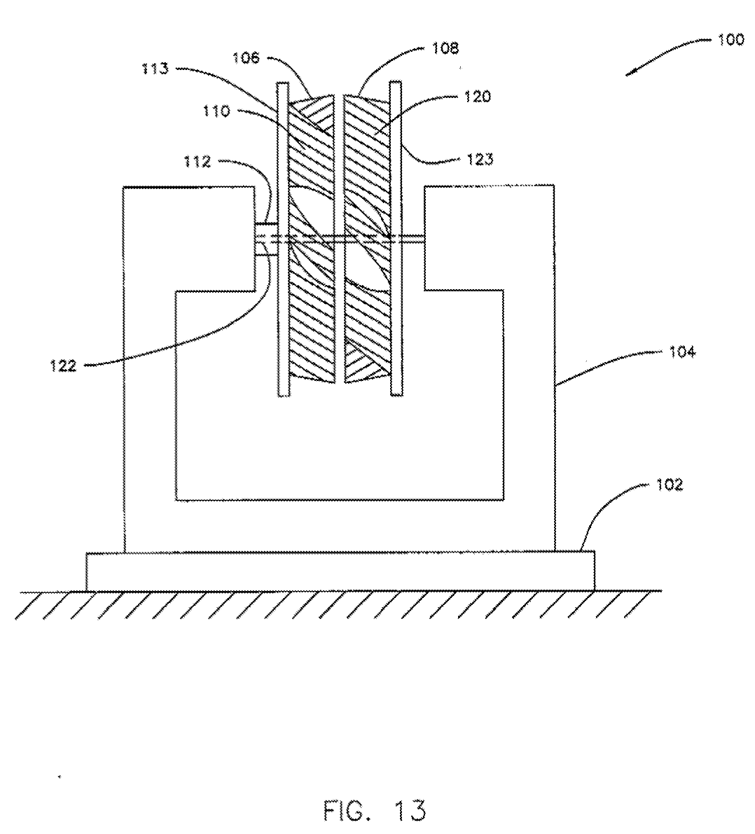

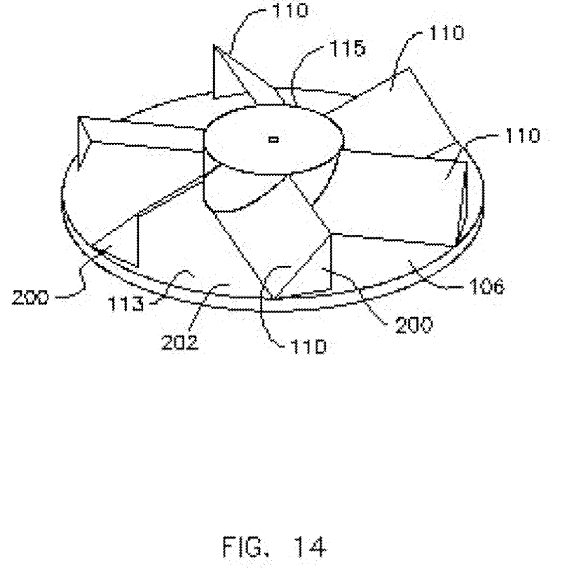

In the above embodiments, each of the shafts 112, 122 extends in a vertical direction. In such cases, the wind turbine 100 may be called a vertical-axis wind turbine (VAWT). However, in other embodiments, the rotors 106, 108 can have different orientations, and the shafts 112, 122 may extend in different directions. For example, in other embodiments, each of the shafts 112, 122 may extend in a horizontal direction (FIG. 13). In such cases, the wind turbine 100 may be called a horizontal-axis wind turbine (HAWT). Also, in other embodiments, instead of having two shafts 112, 122 that are positioned coaxially relatively to each other, the wind turbine 100 of FIG. 12 may have a configuration that is similar to that shown in FIG. 7. In such cases, the shaft 112 is fixedly secured to one of the rotors, and extend through an opening at the other one of the rotors. The shaft 112 may be coupled to a first gearbox, and the other rotor may be coupled to a second gearbox at the periphery of the rotor. Also, in other embodiments, the HAWT turbine 100 may have more than two rotors.

In any of the embodiments described herein, the wind turbine 100 may include additional components for improving the efficiency of the wind turbine 100. For example, in some embodiments, the wind turbine 100 may include a plurality of peripheral covers 200 that are in operative positions relative to the respective blades 110 (FIG. 14). As shown in the figure, each cover 200 is located at a periphery of the rotor, and is secured to the respective blade 110. In some embodiments, the cover 200 and its corresponding blade 110 may be manufactured as a single unit, or alternatively, may be coupled together using a securing mechanism. A space 202 exists between adjacent covers 200 for allowing wind to enter therethrough. In the illustrated embodiments, each cover 200 has a triangular shape. In other embodiments, each cover 200 may have other shapes, such as a rectangular shape, a trapezoidal shape, etc. During use, the covers 200 allow wind to be trapped in the space that is defined by the blades 110 and the covers 200. This has the effect of increasing the efficiency of the turbine 100 because the wind energy is not lost due to wind escaping from the sides of the rotor. Also, the covers 200 may function like the blades 110 by providing a barrier against which the wind may impinge, thereby turning the rotor. In some embodiments, each cover 200 may be considered to be a part of the blade 110. It should be noted that the covers 200 may be implemented with any of the rotors described herein, such as rotor 106, 108, 300, or 400, or the rotor shown in FIG. 10.

In any of the embodiments described herein, the wind turbine 100 may be used to generate electrical energy for multiple applications. For example, the wind turbine 100 may be part of an electrical energy power plant, which generates electrical energy for a population, such as for a building (e.g., a household, an office, etc.), a village, or a city. Alternatively, the wind turbine 100 may be coupled to a machinery and is used to generate energy specifically for the machinery, such as an air-conditioner, a heater, a vehicle, etc. Thus, as used in this specification, the term “wind turbine” is not limited to energy generating devices that generate energy for multiple applications, and may refer to windmill, or a part of the windmill, that includes a specific machinery powered by wind power, or other energy generating devices that generate energy using wind power. It should be understood that the wind turbine 100 may be used to provide energy for anything (whether stationary objects or moving objects) that requires power.

In any of the embodiments described herein, the wind turbine 100 may be a DC wind turbine, an AC wind turbine, or other types of wind turbine.

It should be noted that the illustrated embodiments of wind turbine generators are for exemplary purposes only, and that they should not limit the scope of the claimed invention.

In the above embodiments, the wind turbine 100 has been described with reference to generating electrical energy using wind power. However, in other embodiments, the wind turbine 100 may be used to generate other types of energy using wind power. For example, in other embodiments, the wind turbine 100 may be used to generate heat energy, electromagnetic energy, or other types of energy.

Also, in any of the embodiments described herein, the wind turbine 100 may be utilized in air, on water, or on land. For example, embodiments of the wind turbine 100 may be incorporated as a part of a plane, a boat, or a land vehicle. In further embodiments, the turbine 100 may also be used in water. In such cases, instead of converting wind power to electrical energy, the turbine 100 converts fluid power to electrical energy.

Although particular embodiments have been shown and described, it will be understood that they are not intended to limit the present inventions, and it will be obvious to those skilled in the art that various changes and modifications may be made without departing from the spirit and scope of the present inventions. The specification and drawings are, accordingly, to be regarded in an illustrative rather than restrictive sense. The present inventions are intended to cover alternatives, modifications, and equivalents, which may be included within the spirit and scope of the present inventions as defined by the claims.

What is claimed:

1. A wind turbine for generating energy, comprising:
a first rotor having a first set of blades and a first shaft; and
a second rotor having a second set of blades and a second shaft;
wherein the first rotor is configured to rotate in a first direction, and the second rotor is configured to rotate in a second direction that is opposite to the first direction.

2. The wind turbine of claim 1, wherein the first shaft has an opening, and the second shaft is located within the opening of the first shaft.

3. The wind turbine of claim 1, further comprising a support structure to which the first and the second rotors are coupled, wherein the first rotor is located next to the second rotor.

4. The wind turbine of claim 1, wherein one of the second set of blades is oriented an at angle for receiving wind that is deflected from one of the first set of blades.

5. The wind turbine of claim 1, further comprising:
a third rotor having a third set of blades and a third shaft;
wherein the third rotor is configured to rotate in a third direction that is opposite to the second direction.

6. The wind turbine of claim 1, wherein the first shaft extends in a horizontal direction or a vertical direction.

7. The wind turbine of claim 1, wherein the first rotor comprises a plurality of peripheral covers that are operatively secured relative to the first set of blades.

8. The wind turbine of claim 1, wherein the first shaft is coupled to a first energy generator, and the second shaft is coupled to a second energy generator.

9. The wind turbine of claim 1, wherein the first and second shafts are coupled to an energy generator.

10. The wind turbine of claim 1, wherein one of the first set of blades has a surface for allowing wind to push thereagainst, and wherein the one of the first set of blades is configured to move in a direction that is the same as a direction of the wind.

11. A wind turbine for generating energy, comprising:
a first rotor having a first set of blades and a first shaft; and
a second rotor having a second set of blades and a second shaft;
wherein one of the first set of blades is oriented to receive wind for turning the first rotor, and wherein one of the second set of blades is oriented an at angle to receive wind that is deflected from one of the first set of blades for turning the second rotor.

12. The wind turbine of claim 11, wherein the first rotor is configured to rotate in a first direction, and the second rotor is configured to rotate in a second direction that is opposite to the first direction.

13. The wind turbine of claim 11, wherein the first shaft has an opening, and the second shaft is located within the opening of the first shaft.

14. The wind turbine of claim 11, further comprising a support structure to which the first and the second rotors are coupled, wherein the first rotor is located next to the second rotor.

15. The wind turbine of claim 11, further comprising:
a third rotor having a third set of blades and a third shaft;
wherein one of the third set of blades is oriented an at angle to receive wind that is deflected from one of the second set of blades for turning the third rotor.

16. The wind turbine of claim 11, wherein the first shaft extends in a horizontal direction or a vertical direction.

17. The wind turbine of claim 11, wherein the first rotor comprises a plurality of peripheral covers that are operatively secured relative to the first set of blades.

18. The wind turbine of claim 11, wherein the first shaft is coupled to a first energy generator, and the second shaft is coupled to a second energy generator.

19. The wind turbine of claim 11, wherein the first and second shafts are coupled to an energy generator.

20. The wind turbine of claim 11, wherein one of the first set of blades has a surface for allowing the wind to push thereagainst, and wherein the one of the first set of blades is configured to move in a direction that is the same as a direction of the wind that pushes against the surface.
